(19) United States
(12) Patent Application Publication
(10) Pub. No.: US 2013/0263263 A1
(43) Pub. Date: Oct. 3, 2013

(54) WEB ELEMENT SPOOFING PREVENTION SYSTEM AND METHOD

(71) Applicants: Alecsander Narkolayev, Rishon Lezion (IL); Nir Shahaf, Ramat Hasharon (IL)

(72) Inventors: Alecsander Narkolayev, Rishon Lezion (IL); Nir Shahaf, Ramat Hasharon (IL)

(73) Assignee: COMITARI TECHNOLOGIES LTD., Rishon Lezion (IL)

(21) Appl. No.: 13/992,899

(22) PCT Filed: Dec. 12, 2011
(86) PCT No.: PCT/IL11/00939

§ 371 Date: Jun. 10, 2013

(30) Foreign Application Priority Data
Dec. 13, 2010 (IL) 2009960

(51) Int. Cl. H04L 29/06

(52) U.S. Cl. CPC H04L 63/1483
USPC 726/22

(57) ABSTRACT

A method of inspecting Web elements for real-time classification and detection of Web elements spoofing attempts, according to which trustworthy Web locations are identified for generating a database of safe zones. For each inspected element, it is checked whether or not its top frame URL is included in the database, and if it is included, the element is classified as suspected in Web elements location spoofing attempt.

### FIELD OF THE INVENTION

The present invention relates to security of information delivered over a data network. More particularly, the invention relates to a method and a system for preventing Web elements spoofing.

### BACKGROUND OF THE INVENTION

Recently, Web element spoofing is a common phenomenon over the internet. Web element spoofing is the action of copying Web elements (e.g., login page, CSS etc) from a Web site and placing them on another Web site. There are several possible purposes for doing so, from saving development costs to conducting frauds. Since most of these purposes are financially based, a financial damage is usually experienced by the owner of the Web site from which the Web elements are copied. In addition to the problem of Web element spoofing, additional frauds include spoofing the Uniform Resource Locator (URL) of the Web element, which makes it even more difficult to identify and prevent.

Web element spoofing has many instances on the Web. One example is Web design theft. One can save development costs by simply copying Cascading Style Sheets (CSS) files and images from other Web sites, and incorporating them into his own Web site. Since there is nothing binding the content together with its original location, there is currently no simple way to automatically identify the act of copying and using the content.

Another instance of the problem is Web elements content spoofing. Web elements content spoofing is a method used for obtaining sensitive information, such as login credentials or credit card numbers by masquerading as a trustworthy entity. During Web elements content spoofing attack an attacker creates a Web site which is visually almost identical to a legitimate Web site (e.g. a bank Web site). The attacker then lures innocent users to enter his site, for example by sending links in emails, instant messaging services, social networks, and pages redirection techniques redirection techniques. While browsing in the fake Web site, users are encouraged to type-in their sensitive information which is then stored. The stored information may be utilized by the attacker for conducting financial frauds

An additional method to obtain sensitive information is Web elements location spoofing attack. Web elements location spoofing attacks evolve redirecting the legitimate Web site's traffic to a phished Web site (by changing local configuration, or by exploiting vulnerabilities in the routers/DNS server software, for example).

There are several existing methods which attempt to prevent innocent users from sending their sensitive information over the network to Web elements content spoofing Web sites. The most common approach to solve Web elements content spoofing problem nowadays is by URL blacklisting. Client-side software and Web gateways maintain lists of URLs considered being malicious, including Web elements content spoofing URLs. The Client-side software and the Web gateways can block (or warn) any attempt accessing these URLs. However, this method suffers from a long response time, namely, significant amount of time passes between the attack outbreak and the time the malicious URL is incorporated into the configuration of the attack mitigation software. In order for a Web elements content spoofing URL to be added to the configuration, the URL needs to be reported, a configuration update to be created, and the update then needs to be pushed to all devices. This process takes at best several days, and during this time, users are exposed to the Web elements content spoofing Web site with virtually no protection.

A large portion of URLs is obtained using emails scanning systems. Such systems are learning machines trained to identify emails that appear to be spam or online scams. Those emails are then manually scanned looking for malicious Web content pointed by them, including Web elements content spoofing Web sites. Since this is one of the most common methods for obtaining the locations of Web elements content spoofing Web sites, the time gap is even more severe. Many Web elements content spoofing attacks distribute the location of the Web elements content spoofing Web sites not by email, but by other means (e.g., Instant Messaging services, social networks, blogs, forums and other advanced redirection techniques).

Another method of preventing Web elements content spoofing attempts is based on preventing same password usage on several sites. Whenever a Web elements content spoofing attempt succeeds, an innocent user submits the same password he uses for a legitimate Web site (the user's bank's site, for instance) to the Web elements content spoofing site. Therefore, preventing users from using the same password for several Web sites prevents Web elements content spoofing attempts. However, since many people use the same password (or a few passwords) as their login credentials for most of the Web sites they are using, this method causes a significant number of false positives, which makes the Web elements content spoofing detecting system far from reliable. False positives also occur since users tend to choose dictionary based words as passwords, and type those passwords as text in other applications (e.g., blog). Therefore the system implementing this method would wrongly identify a Web elements content spoofing attempt.

Web frames (e.g., frame, IFrame, framesets) allow presenting documents in multiple views, which may be independent windows or sub-windows. Multiple views offer designers a way to keep certain information visible, while other views are scrolled or replaced. For example, within the same window, one frame might display a static banner, a second a navigation menu, and a third the main document that can be scrolled through or replaced by navigating in the second frame. Frameset refer to the display of two or more web pages or media elements displayed side-by-side within the same browser window. An Inline Frame (IFrame) is a document (e.g., HTML, XML, etc) embedded inside another document (e.g., HTML, XML, etc) on a Web site. IFrames and nested IFrames elements are often used to deliver content from one source into another source. Due to the IFrames security definitions, the visibility of the site page parameters (e.g., URL) and data where the content is delivered to is severely limited.

Another system drawback is keystroke loggers, namely a client-side script (e.g., JaveScript) for tracking the keyboard keys strikes provided by the user. By adding a keystroke logger to the malicious Web site, the attacker can get the password typed-in, or at the worst case, the entire password without the last character (since the system cannot be certain that a known password is typed-in until the last character). This is often sufficient information for guessing the entire password.

Another method of preventing Web elements content spoofing attempts is based on pages fingerprinting as discloses in WO2009/023315 (Benea et al). The pages fingerprinting method evolve a constant scan of all accessed Web sites. The method calculates a fingerprint of the binary representation of the Web page. The calculation is accurate and based on the bytes contained in the document. When a known fingerprint is encountered, the requested URL is compared with the URL where the same fingerprint was formerly encountered. The assumption is that the same page should not exist in two different URLs. However, several problems are posed by this approach.

The main problem with Benea's method is that the calculations are too tight. Small changes in the page on the Web elements content spoofing Web site may deceive the fingerprint engine (attacker can manually create the phished site or make visually insignificant changes in the binary representation of the Web site). A second problem (caused by the same reason) is that legitimate changes done in the original Web site will also be considered as “Web elements content spoofing” attempts causing a significant number of undesired false positives.

Benea's method does not solve the problem of Web elements location spoofing frauds successfully. The Web elements location spoofing protection is not performed in real time, the IP address of all protected Web sites are learned offline. This solution is sensitive to changes in servers addressing, namely when a new IP address is mapped to the Web site's domain IP address, false positives occur. Furthermore, when an IP address is no longer used, an attacker can overtake it and deceive the fingerprint engine. When a Web site is externally load balanced (DNS load balancing), according to the process described in Benea's application, false positives may occur until all IP address are accessed (the system needs to be taught separately to identify each and every IP address).

In order to obtain sensitive information from innocent users, an attacker may create a Web site containing a keystroke logger and an HTML frame with an attacked site (e.g. bank Web site login page). As far as an innocent user is concerned, he is accessing a real Web site. However, once the innocent user logs into the application, the attacker obtains his login credentials. Benea's method compares the URL where the fingerprint was originally encountered with the fingerprint of the currently inspected page. In the case described here, the URL of the inspected page is as expected, although the page should not be considered as safe.

The methods used today have not yet provided satisfactory solutions to the problem of Web elements spoofing. Therefore, there is a need for a system that helps detecting Web elements content spoofing and Web elements location spoofing attacks and preventing attackers from obtaining sensitive information from innocent users, while significantly reducing the number of false positives.

It is an object of the present invention to provide a system for detecting Web elements spoofing (e.g. content and location spoofing, pharming, phishing, and CSS theft) while maintaining a significant low number of false alarms.

It is another object of the present invention to prevent innocent users from providing their sensitive information while browsing in a fake Web site.

It is a further object of the present invention to work effectively from the moment the malicious web site becomes online.

Still another object of the present invention is to identify Web elements content spoofing attempts from all source (including instant messaging services, social networks, blogs, forums, redirection techniques, links in documents and emails etc.).

It is another object of the present invention to automatically detect Web elements spoofing attempts, without any need of manual intervention.

Still another object of the present invention is to prevent malicious Web sites from obtaining user's private information by using keystroke loggers through web frames.

It is another object of the present invention to prevent viruses and malicious softwares from redirecting users to Web elements content spoofing sites.

Further purposes and advantages of this invention will appear as the description proceeds.

### SUMMARY OF THE INVENTION

In a first aspect, the invention is directed to a method of inspecting Web elements for real-time classification and detection of Web elements spoofing attempts, comprising the steps of: (a) identifying trustworthy Web locations for generating a database of safe zones; (b) for each inspected element, checking whether or not its top frame URL is included in the database, if it is included, classifying the element as suspected in Web elements location spoofing attempt; (c) looking for patterns to identify known Web content in the element, if no visual consequences are identified, classifying the element as unknown; (d) checking whether the known element is in an HTML frame or not, if it is in an HTML frame, classifying the element as unsafe; (e) checking whether or not the URL of the element points to an expected location for serving its content, if the location is expected, classifying the element as suspected in Web elements location spoofing attempt; (f) checking whether or not the URL host is an IP address, if it is not an IP address, classifying the element as unsafe; (g) resolving the IP address to domain name; and (h) checking whether or not the resolved URL points to an expected location, if the location is expected, classifying the element as safe, otherwise, classifying the element as unsafe.

In a second aspect, the invention is directed to a real-time method of inspecting Web elements for real-time classification and detection of Web elements spoofing attempts, comprising the steps of: (a) checking whether or not the URL is an SSL encrypted location, if it is not an SSL encrypted location, resolving the IP address to which the Web browser is accessing to a domain name on a trusted DNS server; (b) comparing the returned domain name against the domain name in the URL, if the domain name matches the one on the URL, classifying the element as safe, else classifying the element as unsafe; (c) if the URL is an SSL encrypted location, checking whether or not the SSL certificate is valid, if the SSL certificate is not valid, resolving the IP address to a domain name and jumping to step (b); and (d) extracting the domain name from the certificate and comparing it against the domain name from the URL, if the domain names are not the same, the content is classified as unsafe, else, resolving the IP address to a domain name and jumping to step (b).

In an embodiment of the invention the patterns may have visual consequences which prevent exact calculation for identifying the Web page, thus the identification is not sensitive to minor content changes and the number of false positives alarms is minimal.

In an embodiment of the invention the identification of trustworthy Web locations may be done by matching the URL of the inspected content against a set of known content location patterns.

In one embodiment, the method is implemented over client side or over web gateways.

In an embodiment of the invention the Web elements spoofing attacks are detected from sources taken from the group consisting of instant messaging services, social networks, blogs, forums, redirection techniques, links in documents, and links sent by emails.

In one embodiment, the method further comprises preventing known content to be loaded in Web frames, thus preventing malicious Web sites from obtaining user's private information by using keystroke loggers.

### BRIEF DESCRIPTION OF THE DRAWINGS

The above and other characteristics and advantages of the invention will be better understood through the following illustrative and non-limitative detailed description of embodiments thereof, with reference to the appended drawings, wherein:

FIG. 1 is a schematic flow chart of the process executed by the Web element content spoofing detection engine; and

FIG. 2 is a schematic flow chart of the process executed by the Web element location spoofing detection engine.

### DETAILED DESCRIPTION OF THE INVENTION

In the following description, for the purpose of illustration, numerous specific details are provided. As will be apparent to the skilled person, however, the invention is not limited to such specific details and the skilled person will be able to devise alternative arrangements.

The system proposed by the present invention offers an accurate real-time method for preventing web element spoofing. This method can be implemented both as a client side software, over end-user systems (e.g., as a web browser plug-in), and over web gateways, in an enterprise hardware unit. The system is adapted to inspect all the Web traffic for detecting Web elements spoofing attacks (e.g., phishing, pharming, CSS theft). The system comprises engines for detecting changes in Web sites, ‘safe zones’, namely known and trustworthy web locations, and Web element content and location spoofing.

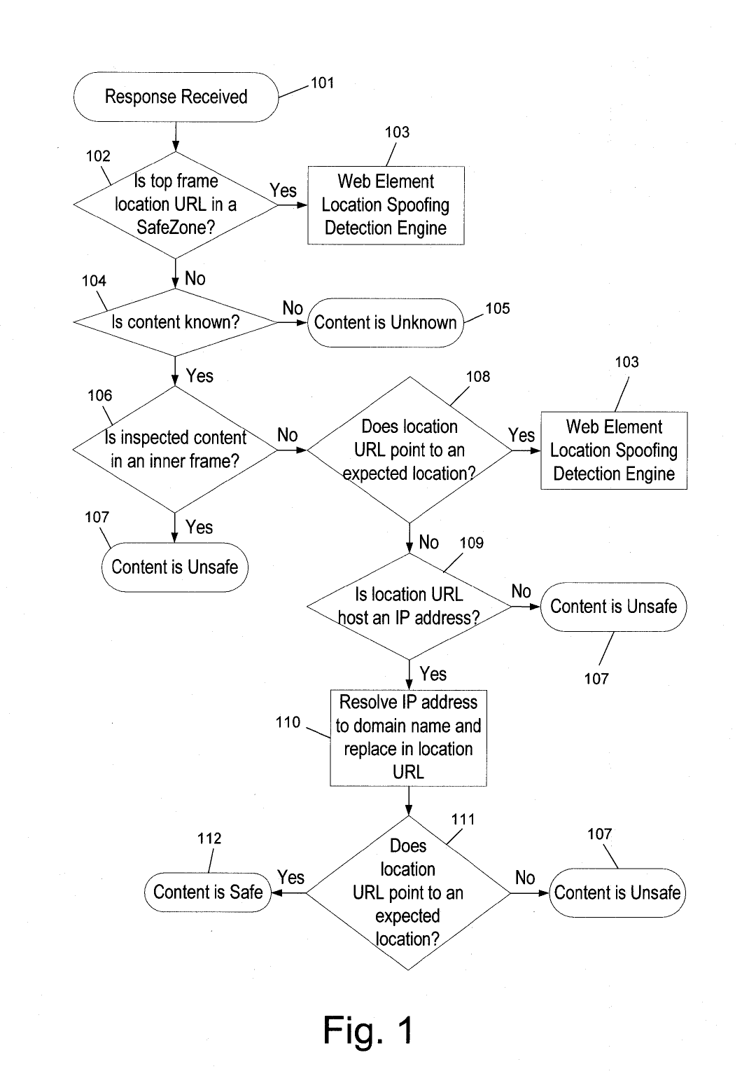

FIG. 1 is a schematic flow chart of the process executed by the Web element content spoofing detection engine for preventing Web elements content spoofing attempts. The Web elements content spoofing detection engine is a subsystem responsible for deciding whether a page surfed by an innocent user is a spoofing attempt or not. The engine runs over the web traffic and for every item loaded decides whether the content is safe or not. In one embodiment, the verdict may be one of three possible options: the content is safe, the content is unsafe, or the content is unknown and therefore no meaningful information can be provided regarding its integrity.

The process executed by the Web elements content spoofing detection engine starts in step 101 when a response is received, namely, transferring files to inspect. In the next step 102, the system checks whether or not the URL of the served content is inside one of the known ‘safe zones’. In one embodiment, this check is executed by the ‘safe zones’ detection engine, described hereinafter. If the URL of the served content is included in one of the known ‘safe zones’, the system executes step 103, and the Web element location spoofing detection engine checks the URL to make sure that this not a Web elements location spoofing (e.g., pharming) attempt. This Web element location spoofing detection engine will make the final decision.

If the URL of the served content is not inside one of the known ‘safe zones’, the system executes step 104 and utilizes the content recognition engine (described hereinafter) to check whether the content loaded is a known Web page or known content. If the system does not recognize the content or the Web page, then the content is declared as unknown 105. If the content is a known page, the system checks in step 106 whether the known content is in a Web frames. If the content is in a Web frame, it is declared as unsafe 107 to prevent usage of key loggers in external frames. Thus, the system provides protection against viruses and malicious softwares installed on the computer, which automatically redirects users to Web elements content spoofing sites when attempting to access legitimate sites or when opening browser windows.

If the content is not in a Web frame, the system checks in step 108 whether or not the URL of the content matches a pattern describing the locations expected for serving this content. If the URL points to an expected location, the system executes step 103, and the Web element location spoofing detection engine checks the URL to make sure that this not a Web elements location spoofing attempt. This Web element location spoofing detection engine will make the final decision. The entire process is executed automatically by the system engines, thus the Web elements content spoofing and Web elements location spoofing detection according to the system of the present invention does not require any manual intervention.

If the content is not located where the system expects it to be, this may be either a spoofing attempt, or a user accessing the Web application by using an IP address instead of a fully qualified domain name. The system then checks in step 109 whether or not the ‘host’ part of the URL is an IP address. If it is not an IP address, the content is declared unsafe 107. If the ‘host’ part is actually an IP address, then the system executes step 110 and performs a reverse Domain Name System (DNS) lookup using a safe and encrypted protocol in a trusted server, and replaces the IP address with the fully qualified domain name in the URL. The reverse DNS lookup is done by the IP to domain resolving subsystem.

The role of the IP to domain name resolving subsystem is to securely resolve the IP address in order to prevent Web elements location spoofing attempts. Whenever there is a need to resolve the IP address to a domain name, the system sends a resolving request using a proprietary encrypted protocol to a proprietary server owned by the implementer. This server acts as a proxy, decrypting and translating the proprietary protocol into DNS queries and sends them to a proprietary DNS server, also owned by the software implementer. This DNS server then continues resolving the IP address communicating with trusted DNS servers on the internet (such as root nameservers). While performing this process, the proprietary DNS server accesses the internet using a different IP address than the one on which the proxy server accepts requests (thus, lowering the risk for attacks, since the proxy server is a well-known server).

In the next step 111, the system checks again whether or not the URL of the content matches the expected pattern. If the URL matches the expected pattern, the system decides that the content is safe 112, and if the URL does not match the expected pattern the system decides that the content is unsafe 107.

The ‘safe zones’ detection engine is utilized by the Web elements content spoofing detection engine. This subsystem is responsible for identifying known and trustworthy Web locations. The identification is done by matching the URL of the inspected content against a set of known content location patterns. For example, for the Web elements content spoofing detection engine, the patterns describe the URLs of login pages and transaction forms of the real Web sites of the organization the system is protecting. In order to prevent from attackers to simply create a Web site with a keystroke logger and the attacked Web site in an HTML frame, the subsystem uses the URL of the top frame of the page for the pattern matching.

The content recognition engine is utilized by the Web elements content spoofing detection engine to identify known Web content. The content recognition engine decides for each page or content provided to it, whether or not this content is known as one of the known Web sites the system is protecting. For example, for the Web elements content spoofing detection engine, the content recognition engine assumes that for a Web elements content spoofing fraud to be successful, the Web page needs to be visually almost identical to the real web page it is mimicking. Therefore, the system looks for patterns that have visual consequences. In one embodiment those visual consequences can be: looking for image patterns in the rendered page, such as the company logo, or looking for textual patterns in the page with visual consequences (both presented text and HTML tags or elements) representing the login/form section where the innocent user is expected to type-in the sensitive information. The searched patterns are crucial for a Web elements content spoofing attack to succeed and therefore evading the content recognition engine without severely damaging the attack's success probability is difficult. Typically, users will not be fooled to type-in their credentials into the phished site if it is ‘too different visually’ compared to the real site.

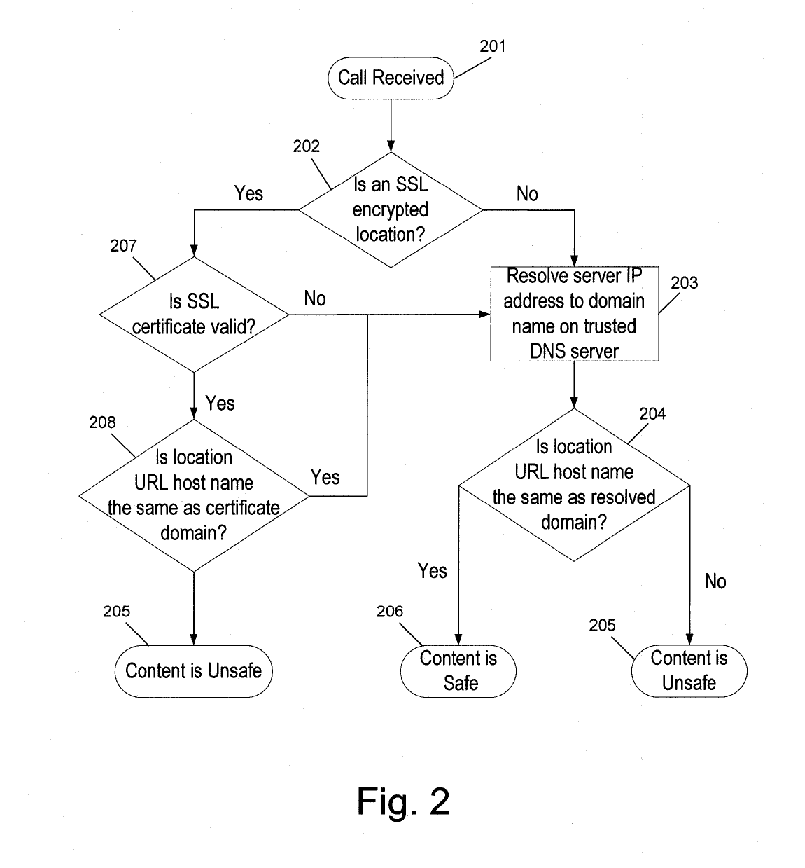

FIG. 2 is a schematic flow chart of the process executed by the Web element location spoofing detection engine for preventing Web elements location spoofing attacks. The Web element location spoofing detection engine is used after the content is recognized and the URL matches the corresponding pattern describing the expected locations allowed to serve the content (or content is served inside ‘safe zones’). In order to prevent Web elements location spoofing attacks the system then uses techniques for validating the integrity of the host name to check whether this is a Web elements location spoofing attack or not.

The process executed by the Web elements location spoofing detection engine starts in step 201 when a call is received from the Web elements content spoofing detection engine. In the next step 202, the system checks whether or not the URL is an SSL encrypted location. If it is not, step 203 is executed wherein the system performs the reverse DNS lookup of the IP address to which the Web browser is accessing in a trusted DNS server using the IP to domain name resolving subsystem. The system then checks in step 204 whether the returned domain name matches the domain name in the URL. If the domain name indeed matches the one in the URL, the Web elements location spoofing detection engine decides that the content is safe 205. Otherwise the Web elements location spoofing detection engine decides that this is a Web elements location spoofing attempt and that the content is unsafe 206.

If during the check of the location in step 202 the system finds that the location is an SSL encrypted location, the system checks, in step 207 whether or not the SSL certificate is valid. If the SSL certificate is not valid, the certificate can not be trusted and the system treats this page as any other non-SSL content by jumping to step 203 and continues the process from there. If the SSL certificate is valid, the system extracts the domain name from the certificate and compares it in step 208 to the domain name from the URL. If the domain names are not the same, the content is classified as unsafe 205. If the domain names are the same, the system jumps to step 203 and continues the process from there.

The site changes detection subsystem is a separate independent component. The legitimate Web sites protected by the system may change occasionally. Due to the ‘safe zone’ mechanism such change will not cause false positives. However, this will let attackers create undetectable spoofed web sites, using the new design of the site since the system is unaware of it. An offline process (not on the innocent user's computer or on the Web gateway, but on a central server) periodically fetches all the current protected content from the legitimate Web sites and makes sure the content recognition engine identifies them correctly. If the subsystem identifies a changed page, the content recognition engine is update accordingly to make sure this page is identified.

The method according to the present invention does not depend on knowledge specific to a single instance of spoofed content. Therefore, the system works as soon as an innocent user attempts to access a malicious web site. The system does not require any configuration updates which allow it to work properly from the moment the malicious web site becomes online. The system needs to be taught if new legitimate Web sites are protected.

The system provides protection against all attack sources since all the Web traffic is inspected. The traffic generated by the innocent user is constantly checked, and Web elements content spoofing attempts are automatically detected. The system does not require to be learned by the end user. The system is adapted to identify Web elements content spoofing attempts from all source (including instant messaging services, social networks, blogs, forums, redirection techniques, links in emails and documents etc), and not only links sent by emails. Since the system does not allow known content (e.g., login pages) to be loaded in Web frames (except in ‘safe zones’), it prevents malicious Web sites from obtaining user's private information by using keystroke loggers.

The system according to the present invention reduces the rate of the false negative reported compared to methods utilizing exact calculation to identify the Web page. The system is therefore not sensitive to minor content changes. Additionally, the patterns searched have visual meaning in the presented Web page, hence attempts to evade the engine implemented using the described method will probably change the look and feel of the page created, and the Web elements content spoofing Web site will most certainly not deceive successfully any legitimate user (e.g. remove/replace the company logo). Since legitimate web site sometimes change their appearance and functionality, the system according to the present invention comprises the ‘safe zones’ component, which prevents the system from wrongly announcing legitimate web sites as Web elements content spoofing web sites, namely maintaining a significant low number of false positives alarms. Additionally, the site changes detection subsystem assists in detecting the change and updating the page recognition engine accordingly (with the new visual characteristics of the page).

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method of inspecting Web elements for real-time classification and detection of Web elements spoofing attempts, comprising the steps of:
(a) identifying trustworthy Web locations for generating a database of safe zones;
(b) for each inspected element, checking whether or not its top frame URL is included in said database, if it is included, classifying said element as suspected in Web elements location spoofing attempt;
(c) looking for patterns to identify known Web content in said element, if no visual consequences are identified, classifying said element as unknown;
(d) checking whether said known element is in an HTML frame or not, if it is in an HTML frame, classifying said element as unsafe;
(e) checking whether or not the URL of the element points to an expected location for serving its content, if the location is expected, classifying said element as suspected in Web elements location spoofing attempt;
(f) checking whether or not the URL host is an IP address, if it is not an IP address, classifying said element as unsafe;
(g) resolving said IP address to domain name; and
(h) checking whether or not said resolved URL points to an expected location, if the location is expected, classifying said element as safe, otherwise, classifying said element as unsafe.

2. A method of inspecting Web traffic elements for real-time classification and detection of Web elements location spoofing attempts, comprising the steps of:
(a) checking whether or not the URL is an SSL encrypted location, if it is not an SSL encrypted location, resolving the IP address to which the Web browser is accessing to a domain name on a trusted DNS server;
(b) comparing the returned domain name against the domain name in the URL, if the domain name matches the one on said URL, classifying said element as safe, else classifying said element as unsafe;
(c) if the URL is an SSL encrypted location, checking whether or not the SSL certificate is valid, if the SSL certificate is not valid, resolving the IP address to a domain name and jumping to step (b); and
(d) extracting the domain name from the certificate and comparing it against the domain name from the URL, if the domain names are not the same, the content is classified as unsafe, else, resolving the IP address to a domain name and jumping to step (b).

3. The method according to claim 1, wherein the patterns have visual consequences which prevent exact calculation for identifying the Web page, thus said identification is not sensitive to minor content changes and the number of false positives alarms is minimal.

4. The method according to claim 1, wherein the identification of trustworthy Web locations is done by matching the URL of the inspected content against a set of known content location patterns.

5. The method according to claim 1, wherein said method is implemented over client side or over web gateways.

6. The method according to claim 1, wherein Web elements spoofing attacks are detected from sources taken from the group consisting of instant messaging services, social networks, blogs, forums, redirection techniques, links in documents, and links sent by emails.

7. The method according to claim 1, further preventing known content to be loaded in Web frames, thus preventing malicious Web sites from obtaining user's private information by using keystroke loggers.

8. The method according to claim 2, wherein said method is implemented over client side or over web gateways.

9. The method according to claim 2, wherein Web elements spoofing attacks are detected from sources taken from the group consisting of instant messaging services, social networks, blogs, forums, redirection techniques, links in documents, and links sent by emails.

10. The method according to claim 2, further preventing known content to be loaded in Web frames, thus preventing malicious Web sites from obtaining user's private information by using keystroke loggers.
